(19) United States
(12) Patent Application Publication
(10) Pub. No.: US 2017/0222803 A1
(43) Pub. Date: Aug. 3, 2017

(54) COMMUNICATION DEVICE, CRYPTOGRAPHIC COMMUNICATION SYSTEM, CRYPTOGRAPHIC COMMUNICATION METHOD, AND COMPUTER PROGRAM PRODUCT

(71) Applicant: Kabushiki Kaisha Toshiba, Minato-ku (JP)

(72) Inventor: Yoshimichi TANIZAWA, Yokohama (JP)

(73) Assignee: Kabushiki Kaisha Toshiba, Minato-ku (JP)

(21) Appl. No.: 15/266,628

(22) Filed: Sep. 15, 2016

(30) Foreign Application Priority Data
Feb. 2, 2016 (JP) 2016-018299
Sep. 14, 2016 (JP) 2016-179874

(51) Int. Cl. H04L 9/08; H04L 29/06

(52) U.S. Cl. CPC H04L 9/0852; H04L 63/061; H04L 63/0853

(57) ABSTRACT

A communication device according to an embodiment is a communication device that communicates with another communication device using an encryption key shared through a quantum key distribution and includes a communication unit, an encrypting unit, a first checking unit, and a communication control unit. The communication unit performs communication of data with the another communication device. The encrypting unit encrypts data using the encryption key. The first checking unit checks an accumulation amount of the encryption key. The communication control unit control transmission of dummy data according to checked results.

### CROSS-REFERENCE TO RELATED APPLICATIONS

This application is based upon and claims the benefit of priority from Japanese Patent Application No. 2016-018299, filed on Feb. 2, 2016, and No. 2016-179874, filed on Sep. 14, 2016; the entire contents of which are incorporated herein by reference.

### FIELD

Embodiments described herein relate generally to a communication device, a cryptographic communication system, a cryptographic communication method, and a computer program product.

### BACKGROUND

A quantum key distribution system includes a transmitting node, a receiving node, and an optical fiber link that connects the transmitting node and the receiving node. The transmitting node continuously transmits single photons to the receiving node through the optical fiber link (quantum communication channel), which is an optical fiber communication channel. After that, the transmitting node and the receiving node exchange control information to each other, thereby sharing an encryption key between the transmitting node and the receiving node with safety. This technology is achieved by a technology generally called “quantum key distribution (QKD)”.

Quantum key distribution uses the uncertainty principle, which is one of the basic quantum-mechanical principles, that photons used to share an encryption key change their physical state when observed. Based on this principle, if an eavesdropper observes photons that contain encryption key information transmitted from the transmitting node on the quantum communication channel, the physical state of the photons is changed, and the receiving node that has received the photons can detect that the photons have been observed by the eavesdropper. Thus, by exchanging control information between the transmitting node and the receiving node on the basis of a sequence of photons obtained at the transmitting node and a sequence of photons detected at the receiving node, a safe encryption key is finally obtained.

Applications that are connected to two nodes (for example, the transmitting node and the receiving node) or included in the nodes perform encryption and decryption using the encryption key shared between the two nodes, and perform cryptographic data communication using a cryptographic communication scheme called “one-time pad”. The one-time pad is a cryptographic communication scheme in which data of one byte is encrypted using an encryption key of one byte and then transmitted, the received data of one byte is decrypted using the same encryption key of one byte, and the encryption key used once is discarded. In the cryptographic data communication using the one-time pad, it is guaranteed by an information theory that it is difficult for the eavesdropper to perform decryption. Further, it is also possible to provide a data authentication function using a hash function of a universal class. A technology in which cryptographic data communication is performed using an encryption key shared through the quantum key distribution is referred to as “quantum encryption technology”.

Here, a technology of concealing (making it difficult to understand) a communication data amount as well as communication content by performing communication of dummy data in addition to communication of real data between devices that performs common cryptographic data communication has been proposed.

However, in the above-described technology, a method of deciding a timing at which dummy data is transmitted, a method of identifying dummy data and real data at a data reception side, and a method of applying to a quantum cryptographic communication system are not explicitly disclosed.

### BRIEF DESCRIPTION OF THE DRAWINGS

FIG. 1 is a diagram illustrating an example of an overall configuration of a quantum cryptographic communication system;

FIG. 2 is a diagram illustrating an example of a hardware configuration of a node;

FIG. 3 is a diagram illustrating an example of a functional block configuration of a node;

FIG. 4 is a diagram for describing an operation of communicating real data;

FIG. 5 is a diagram for describing an operation of communicating dummy data;

FIG. 6 is a diagram for describing an operation of communicating dummy data;

FIG. 7 is a table used for deciding the communication amount of dummy data;

FIG. 8 is a diagram illustrating a configuration of a frame that is communicated according to a first embodiment;

FIG. 9 is a sequence diagram illustrating an operation of cryptographic data communication according to the first embodiment;

FIG. 10 is a diagram for describing an encoding method according to a second embodiment; and

FIG. 11 is a sequence diagram illustrating an operation of quantum cryptographic communication according to the second embodiment.

### DETAILED DESCRIPTION

A communication device according to an embodiment is a communication device that communicates with another communication device using an encryption key shared through a quantum key distribution and includes a communication unit, an encrypting unit, a first checking unit, and a communication control unit. The communication unit performs communication of data with the another communication device. The encrypting unit encrypts data using the encryption key. The first checking unit checks an accumulation amount of the encryption key. The communication control unit control transmission of dummy data according to checked results.

Hereinafter, a communication device, a cryptographic communication system, a cryptographic communication method, and a program according to exemplary embodiments of the present embodiment will be described in detail with reference to the appended drawings. However, since the drawings are schematic, a specific configuration has to be determined with reference to the following description.

### First Embodiment

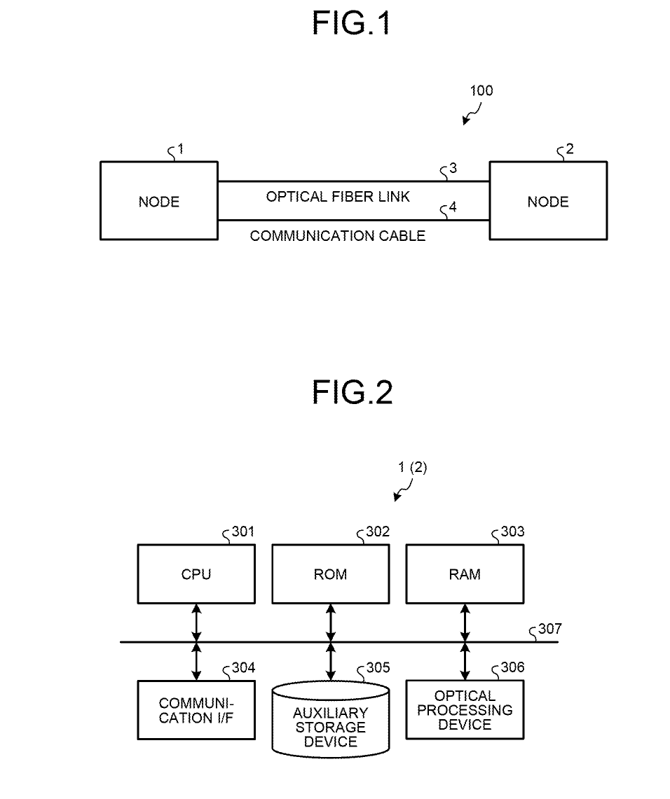

FIG. 1 is a diagram illustrating an example of an overall configuration of a quantum cryptographic communication system. A configuration of a quantum cryptographic communication system 100 will be described with reference to FIG. 1.

The quantum cryptographic communication system 100 (a cryptographic communication system) includes a node 1 (a communication device), a node 2 (a communication device), an optical fiber link 3, and a communication cable 4 as illustrated in FIG. 1.

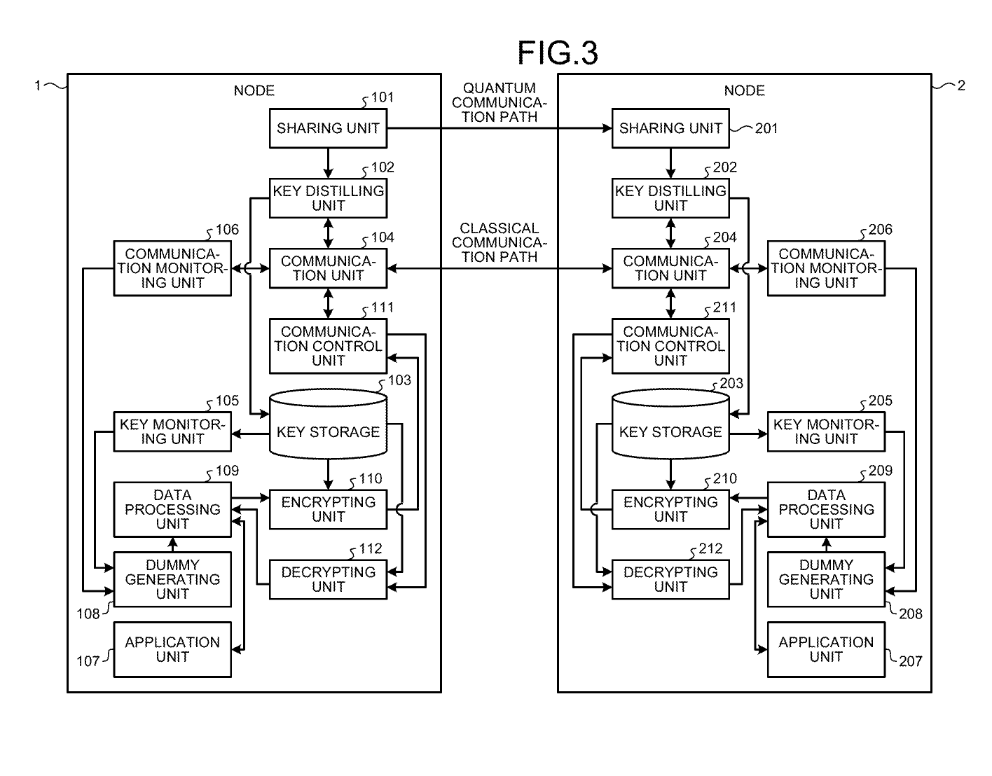

The node 1 is a transmitter that transmits a sequence of photons configured with a single photon which is generated by a laser or the like and serves as the basis for generating an encryption key to the node 2 via the optical fiber link 3. The node 1 generates the encryption key by performing key distillation processing to be described later (sifting processing, error correcting processing, and privacy amplification processing) or the like based on the transmitted the sequence of photons. At the time of the key distillation processing, the node 1 exchanges control data (which is not a single photon but general digital data. Hereinafter, it is also referred to as “key distillation processing data”) with the node 2 via the communication cable 4. Here, the communication cable 4 serving as a communication channel of data (hereinafter, also referred to as “real data”) (regular data) that is communicated by applications (application units 107 and 207 illustrated in FIG. 3 which will be described later) as will be described later and dummy data in addition to the key distillation processing data is also referred to as a “classical communication channel”. The key distillation processing data may be transferred via the optical fiber link 3 between the node 1 and the node 2 instead of the communication cable 4 or may be transferred using any other communication channel (for example, a general Internet line or the like).

The node 2 is a receiver that receives the sequence of photons configured with a single photon serving as the basis for generating the encryption key from the node 1 via the optical fiber link 3. The node 2 generates the same encryption key as the encryption key generated by the node 1 by performing the key distillation processing to be described later (the sifting processing, the error correcting processing, and the privacy amplification processing) or the like based on the received sequence of photons. At the time of the key distillation processing, the node 2 exchanges control data (the key distillation processing data) with the node 1 via the communication cable 4.

The optical fiber link 3 is an optical fiber cable that functions as a quantum communication channel serving as a transmission channel of the single photon output from the node 1. The communication cable 4 is a cable that functions as the classical communication channel used for communicating the real data and the dummy data of the applications as will be described later in addition to the key distillation processing data between the node 1 and the node 2.

In the quantum cryptographic communication system 100 including the node 1 and the node 2, when the eavesdropper observes the sequence of photons transmitted from the node 1 on the optical fiber link 3, the physical state of the photon changes, and the node 2 that has received the photon can recognize that the eavesdropper has observed the photon.

FIG. 2 is a diagram illustrating an example of a hardware configuration of a node. A hardware configuration of a node will be described with reference to FIG. 2. The following description will proceed using the node 1 as an example.

The node 1 includes a central processing unit (CPU) 301, a read only memory (ROM) 302, a random access memory (RAM) 303, a communication I/F 304, an auxiliary storage device 305, and an optical processing device 306 as illustrated in FIG. 2.

The CPU 301 is an operational device that controls an operation of the node 1 in general. The ROM 302 is a non-volatile memory device that stores a basic input/output system (BIOS) which is executed by the CPU 301 to control respective functions or a program such as firmware. The RAM 303 is a volatile memory device that functions as a work memory or the like of the CPU 301.

The communication I/F 304 is an interface for performing data communication through the classical communication channel (the communication cable 4 or the like). For example, the communication I/F 304 may be an interface that supports Ethernet (a registered trademark) such as 10 Base-T, 100 Base-TX, or 1000 Base-T or may be an interface for an optical fiber.

The auxiliary storage device 305 is a non-volatile memory device that stores and accumulates various kinds of programs executed by the CPU 301 and data, an encryption key, and the like which are generated in the process of a sharing operation of an encryption key. The auxiliary storage device 305 is a storage device that can perform storage electrically, magnetically, or optically such as a hard disk drive (HDD), a solid state drive (SSD), a flash memory, or an optical disk.

The optical processing device 306 is an optical device that transmits or receives the sequence of photons through the quantum communication channel. The optical processing device 306 of the node 1 transmits, for example, a sequence of photons configured with a single photon generated to become a polarization state based on base information generated by a base that is randomly selected based on a bit string (a photon bit string) serving as bit information generated according to a random number to the optical processing device 306 of the node 2 through the quantum communication channel (the optical fiber link 3 illustrated in FIG. 1). In other words, each photon of the sequence of photons generated through the optical processing device 306 of the node 1 has information of one bit such as “0” or “1”. The optical processing device 306 of the node 2 receives the sequence of photons from the optical processing device 306 of the node 1 through the quantum communication channel and obtains the photon bit string serving as the bit information by reading the received sequence of photons based on the base information generated by the base that is randomly selected.

The CPU 301, the ROM 302, the RAM 303, the communication I/F 304, the auxiliary storage device 305, and the optical processing device 306 are connected to perform communication with one another via a bus 307 such as an address bus and a data bus.

FIG. 3 is a diagram illustrating an example of a functional block configuration of a node. The functional block configurations of the node 1 and the node 2 will be described with reference to FIG. 3.

The node 1 includes a sharing unit 10, a key distilling unit 102, a key storage 103 (a storage), a communication unit 104, a key monitoring unit 105 (a first checking unit), a communication monitoring unit 106 (a second checking unit), the application unit 107, a dummy generating unit 108 (a generating unit), a data processing unit 109, an encrypting unit 110, a communication control unit 111, and a decrypting unit 112 as illustrated in FIG. 3. The sharing unit 101 and the key distilling unit 102 correspond to an “encryption key sharing unit”. The sharing unit 101 and the key distilling unit 102 may be included in a device (for example, a key sharing device) other than the node 1 and an encryption key may be obtained from the device.

The sharing unit 101 is a function unit that transmits the sequence of photons configured with the single photon generated to become the polarization state based on the base information generated by the basis that is randomly selected based on, for example, the photon bit string serving as the bit information generated according to the random number to a sharing unit 201 of the node 2 through the quantum communication channel (the optical fiber link 3 illustrated in FIG. 1). The sharing unit 101 is implemented by the optical processing device 306 illustrated in FIG. 2.

The key distilling unit 102 is a function unit that performs communication of the key distillation processing data with a key distilling unit 202 of the node 2 through the classical communication channel, and performs the key distillation processing of generating the encryption key based on the photon bit string (the sifting processing, the error correcting processing and the privacy amplification processing). The key distilling unit 102 shares the same encryption key as a result of performing the key distillation processing with the key distilling unit 202.

The key storage 103 is a function unit that accumulates (stores) the encryption key generated by the key distilling unit 102. The key storage 103 is implemented by the auxiliary storage device 305 illustrated in FIG. 2.

The communication unit 104 is a function unit that communicates data with the node 2 through the classical communication channel (the communication cable 4 illustrated in FIG. 1). The communication unit 104 is implemented by the communication I/F 304 illustrated in FIG. 2.

The key monitoring unit 105 is a function unit that monitors an accumulation state of the encryption key accumulated in the key storage 103. Specifically, the key monitoring unit 105 monitors an accumulation amount of the encryption key in the key storage 103, a sharing speed of the encryption key in the key distilling unit 102, a reduction amount of the encryption key in the key storage 103, and the like. The key monitoring unit 105 transfers a monitored result to the dummy generating unit 108.

The communication monitoring unit 106 is a function unit that monitors a communication state of the real data that is communicated on the classical communication channel through the communication unit 104. Specifically, the communication monitoring unit 106 monitors a communication timing and frequency of the real data that is communicated and previous communication timing, history, frequency, or the like of the real data. The communication monitoring unit 106 transfers the monitored result to the dummy generating unit 108.

The application unit 107 is a function unit that is an application performing communication of the real data and generates the real data serving as an encryption target. The application unit 107 transfers the real data generated for transmission to the data processing unit 109.

The dummy generating unit 10e is a function unit that generates the dummy data according to the accumulation state of the encryption key checked by the key monitoring unit 105 and the communication state of the real data checked by the communication monitoring unit 106. The dummy generating unit 108 transfers the generated dummy data to the data processing unit 109.

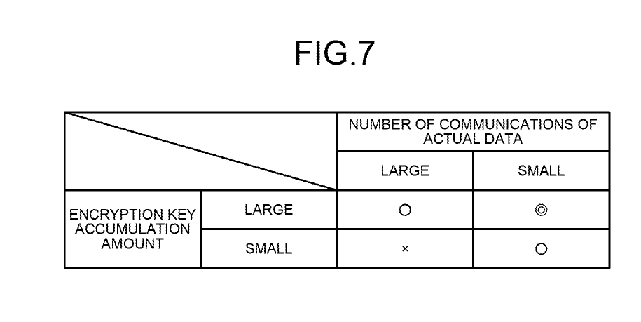

The data processing unit 109 is a function unit that performs data processing of adding and removing a header on the real data generated by the application unit 107 and the dummy data generated by the dummy generating unit 108. The addition and removal of the header will be described later with reference to FIG. 7.

The encrypting unit 110 is a function unit that encrypts the real data and the dummy data using the encryption key accumulated in the key storage 103. The encryption by the encrypting unit 110 is commonly performed according to the one-time pad. A specific encryption operation will be described later.

The communication control unit 111 is a function unit of controlling data communication of the communication unit 104. Particularly, the communication control unit 111 controls a transmission timing at which the encrypted dummy data is transmitted and a communication (transmission) amount of the dummy data in addition to communication control of the encrypted real data through the communication unit 104.

The decrypting unit 112 is a function unit that decrypts encrypted data received through the communication unit 104 using the encryption key accumulated in the key storage 103. Here, the encrypted data indicates data that has been encrypted and includes both the encrypted real data and the encrypted dummy data. The decryption by the decrypting unit 112 is commonly performed according to the one-time pad. A specific decryption operation will be described later.

The key distilling unit 102, the key monitoring unit 105, the communication monitoring unit 106, the application unit 107, the dummy generating unit 108, the data processing unit 109, the encrypting unit 110, the communication control unit 111, and the decrypting unit 112 are implemented by reading a program stored in the auxiliary storage device 305 or the like onto the RAM 303 and executing the program through the CPU 301 illustrated in FIG. 2. The key distilling unit 102, the key monitoring unit 105, the communication monitoring unit 106, the application unit 107, the dummy generating unit 108, the data processing unit 109, the encrypting unit 110, the communication control unit 111, and the decrypting unit 112 are not limited to the example in which all the components are implemented by executing the program, and at least any one of the components may be implemented by, for example, a hardware circuit such as an Application Specific Integrated Circuit (ASIC), a Field-Programmable Gate Array (FPGA), or any other integrated circuit.

The sharing unit 101, the key distilling unit 102, the key storage 103, the communication unit 104, the key monitoring unit 105, the communication monitoring unit 106, the application unit 107, the dummy generating unit 108, the data processing unit 109, the encrypting unit 110, the communication control unit 111, and the decrypting unit 112 illustrated in FIG. 3 are conceptual expressions of functions, and the present embodiment is not limited to such components. For example, in the node 1 illustrated in FIG. 3, a plurality of function units that are illustrated as independent function units may be configured as a single function unit. On the other hand, in the node 1 illustrated in FIG. 3, a function of one function unit may be divided into two or more and configured as a plurality of function units.

The node 2 includes the sharing unit 201, the key distilling unit 202, a key storage 203 (a storage), a communication unit 204 (a communication unit), a key monitoring unit 205 (a first checking unit), a communication monitoring unit 206 (a second checking unit), an application unit 207, a dummy generating unit 208 (a generating unit), a data processing unit 209 (a data processing unit), an encrypting unit 210 (an encrypting unit), a communication control unit 211 (a communication control unit), and a decrypting unit 212 (a decrypting unit) as illustrated in FIG. 3. The sharing unit 201 and the key distilling unit 202 correspond to an “encryption key sharing unit”.

The sharing unit 201 is a function unit that acquires the photon bit string serving as the bit information by receiving the sequence of photons from the sharing unit 101 of the node 1 through the quantum communication channel and reading the received sequence of photons based on the base information generated by the basis that is randomly selected. The sharing unit 201 is implemented by the optical processing device 306 illustrated in FIG. 2.

The key distilling unit 202 is a function unit that performs communication of the key distillation processing data with the key distilling unit 102 of the node 1 through the classical communication channel and performs the key distillation processing of generating the encryption key based or, the photon bit string (the sifting processing, the error correcting process and the privacy amplification processing). The key distilling unit 202 shares the same encryption key as a result of performing the key distillation processing with the key distilling unit 102.

The key storage 203 is a function unit that accumulates (stores) the encryption key generated by the key distilling unit 202. The key storage 203 is implemented by the auxiliary storage device 305 illustrated in FIG. 2.

The communication unit 204 is a function unit that communicates data with the node 1 through the classical communication channel (the communication cable 4 illustrated in FIG. 1). The communication unit 204 is implemented by the communication I/F 304 illustrated in FIG. 2.

The key monitoring unit 205 is a function unit that monitors the accumulation state of the encryption key accumulated in the key storage 203. Specifically, the key monitoring unit 205 monitors the accumulator amount of the encryption key in the key storage 203, the sharing speed of the encryption key in the key distilling unit 202, the reduction amount of the encryption key in the key storage 203, and the like. The key monitoring unit 205 transfers a monitored result to the dummy generating unit 208.

The communication monitoring unit 206 is a function unit that monitors the communication state of the real data that is communicated on the classical communication channel through the communication unit 204. Specifically, the communication monitoring unit 206 monitors a communication timing and frequency of the real data that is communicated and previous communication timing, history, frequency, or the like of the real data. The communication monitoring unit 206 transfers the monitored result to the dummy generating unit 208.

The application unit 207 is a function unit that is an application performing communication of the real data and generates the real data serving as an encryption target. The application unit 207 transfers the real data generated for transmission to the data processing unit 209.

The dummy generating unit 208 is a function unit that generates the dummy data according to the accumulation state of the encryption key checked by the key monitoring unit 205 and the communication state of the real data checked by the communication monitoring unit 206. The dummy generating unit 208 transfers the generated dummy data to the data processing unit 209.

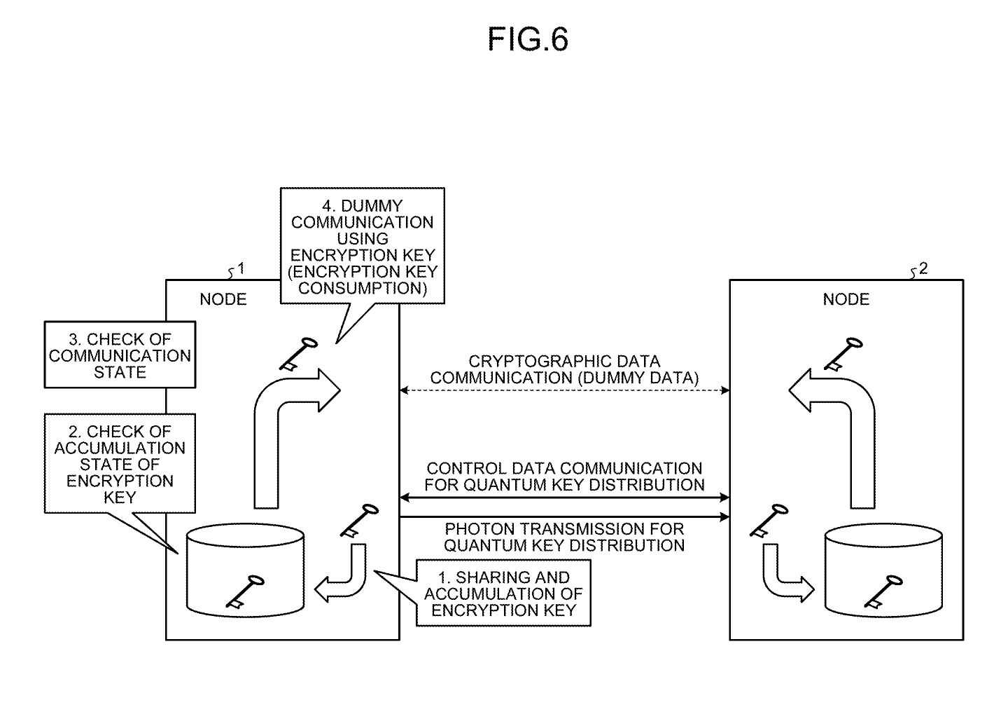

The data processing unit 209 is a function unit that performs addition and removal of a header on the real data generated by the application unit 207 and the dummy data generated by the dummy generating unit 208. The addition and removal of the header will be described later with reference to FIG. 6.

The encrypting unit 210 is a function unit that encrypts the real data and the dummy data using the encryption key accumulated in the key storage 203. The encryption by the encrypting unit 210 is commonly performed according to the one-time pad. A specific encryption operation will be described later.

The communication control unit 211 is a function unit of controlling data communication of the communication unit 204. Particularly, the communication control unit 211 controls a transmission timing at which the encrypted dummy data is transmitted in addition to communication control of the encrypted real data through the communication unit 204.

The decrypting unit 212 is a function unit that decrypts the encrypted data received through the communication unit 204 using the encryption key accumulated in the key storage 203. The decryption by the decrypting unit 212 is commonly performed according to the one-time pad. A specific decryption operation will be described later.

The key distilling unit 202, the key monitoring unit 205, the communication monitoring unit 206, the application unit 207, the dummy generating unit 208, the data processing unit 209, the encrypting unit 210, the communication control unit 211, and the decrypting unit 212 are implemented by reading a program stored in the auxiliary storage device 305 or the like onto the RAM 303 and executing the program through the CPU 301 illustrated in FIG. 2. The key distilling unit 202, the key monitoring unit 205, the communication monitoring unit 206, the application unit 207, the dummy generating unit 208, the data processing unit 209, the encrypting unit 210, the communication control unit 211, and the decrypting unit 212 are not limited to the example in which all the components are implemented by executing the program, and at least arty one of the components may be implemented by, for example, a hardware circuit such as an ASIC, an FPGA, or any other integrated circuit.

The sharing unit 201, the key distilling unit 202, the key storage 203, the communication unit 204, the key monitoring unit 205, the communication monitoring unit 206, the application unit 207, the dummy generating unit 208, the data processing unit 209, the encrypting unit 210, the communication control unit 211, and the decrypting unit 212 illustrated in FIG. 3 are conceptual expressions of functions, and the present embodiment is not limited to such components. For example, in the node 2 illustrated in FIG. 3, a plurality of function units that are illustrated as independent function units may be configured as a single function unit. On the other hand, in the node 2 illustrated in FIG. 3, a function of one function unit may be divided into two or more and configured as a plurality of function units.

The functional block configurations of the nodes 1 and 2 illustrated in FIG. 3 are configuration under the assumption that the nodes 1 and 2 communicate the encrypted data with each other, but the present embodiment is not limited thereto, and one of the nodes 1 and 2 may have only an encrypted data transmission function, and the other may have only an encrypted data reception function. For example, when the node 1 has only the encrypted data transmission function, the node 1 does not receive the encrypted data, and thus the node 1 may not include the decrypting unit 112. Further, when the node 2 has only the encrypted data reception function, the node 2 does not transmit the encrypted data (it is unnecessary to generate the dummy data), and thus the node 2 may not include the key monitoring unit 205, the communication monitoring unit 206, the dummy generating unit 208, and the encrypting unit 210.

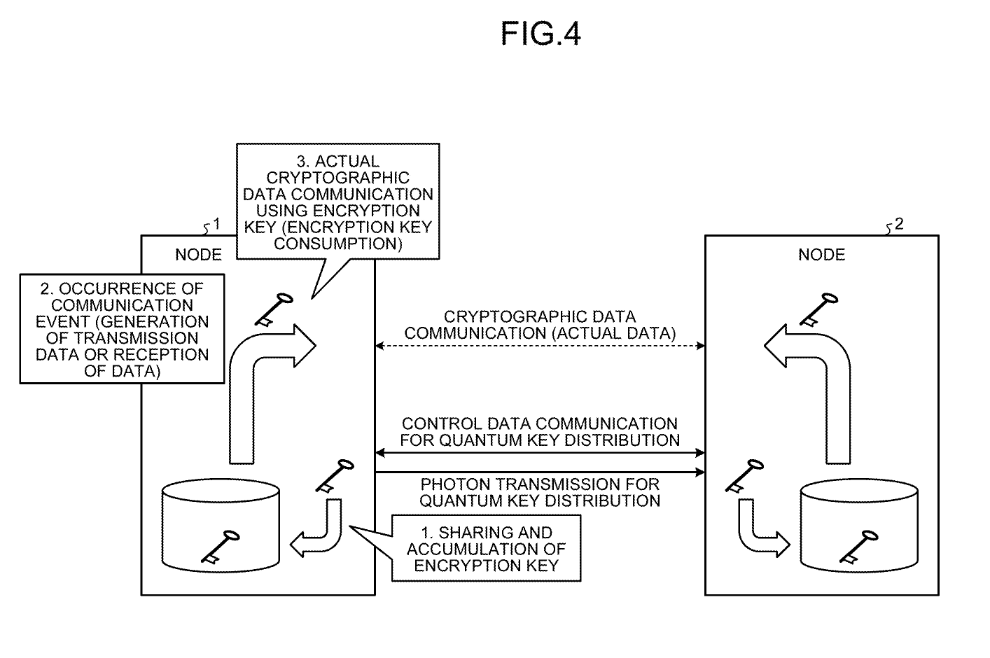

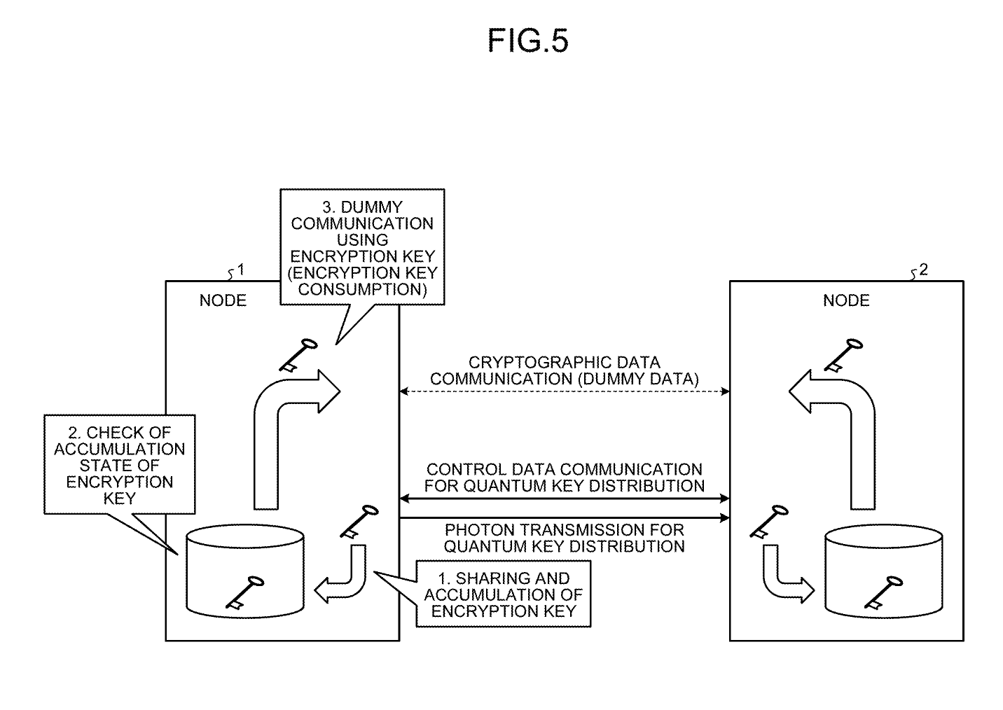

FIG. 4 is a diagram for describing an operation of communicating the real data. FIGS. 5 and 6 are diagrams for describing an operation of communicating the dummy data. An overview of an operation of communicating the encrypted data will be described with reference to FIGS. 4-6.

First, an example of an operation of transmitting data obtained by encrypting the real data among the encrypted data from the node 1 to the node 2 will be described with reference to FIG. 4.

The sharing unit 101 of the node 1 transmits the sequence of photons to the sharing unit 201 of the node 2 through the quantum communication channel, and the key distilling unit 102 performs communication of the key distillation processing data (control data for the quantum key distribution) with the key distilling unit 202 of the node 2 through the classical communication channel, so that the encryption key is generated from the photon bit string. As a result, the encryption key shared between the node 1 and the node 2 is accumulated in the key storage 103. The sharing operation of the encryption key (the quantum key distribution) by the sharing unit 101 and the key distilling unit 102 and the accumulation operation of the encryption key in the key storage 103 are repeatedly performed. The sharing operation and the accumulation operation of the encryption key are the same even in a dummy data communication operation of FIGS. 5 and 6 which will be described later.

Next, a communication event is assumed to occur in the application unit 107. For example, the communication event corresponds to generation of data (the real data) to be transmitted to the outside (here, the node 2) and reception of data from the outside by the application unit 107. Here, a communication event of generation of data (the real data) to be transmitted to the outside is assumed to occur in the application unit 107.

The real data generated by the application unit 107 is transferred to the data processing unit 109, and the data processing unit 109 performs data processing (for example, addition of a header indicating the real data). The encrypting unit 110 encrypts the data that has undergone the data processing by the data processing unit 109 using the encryption key accumulated in the key storage 103. The communication control unit 111 transmits the encrypted data of the real data encrypted by the key storage 103 to the node 2 through the communication unit 104 and the classical communication channel.

In the node 2, the encrypted data received through the communication unit 204 is decrypted using the encryption key accumulated in the key storage 203, and the decrypted real data is transferred to the application unit 207.

Next, an example of an operation of transmitting data obtained by encrypting the dummy data among the encrypted data from the node 1 to the node 2 will be described with reference to FIG. 5.

Similarly to the example of FIG. 4, the sharing operation of the encryption key (the quantum key distribution) by the sharing unit 101 and the key distilling unit 102 and the accumulation operation of the encryption key in the key storage 103 are repeatedly performed.

Then, the dummy generating unit 108 generates the dummy data using a different control scheme according to the accumulation state of the encryption key checked by the key monitoring unit 105. A control scheme of generating the dummy data will be described later.

The dummy data generated by the dummy generating unit 108 is transferred to the data processing unit 109 and undergoes data processing (for example, addition of a header indicating the dummy data) by the data processing unit 109. The encrypting unit 110 encrypts the entire data that has undergone the data processing by the data processing unit 109 or only a header portion of the data using the encryption key accumulated in the key storage 103. The communication control unit 111 transmits the encrypted data of the dummy data encrypted by the key storage 103 to the node 2 through the communication unit 104 and the classical communication channel. The encryption target is not limited to the entire data or the header portion, and a portion including at least the header portion may be the target.

In the node 2, at least the header portion of the encrypted data received through the communication unit 204 is decrypted using the encryption key accumulated in the key storage 203, and when the data is determined to be the dummy data based on the decrypted header portion, the dummy data is discarded.

Next, another example of the operation of transmitting data obtained by encrypting the dummy data among the encrypted data from the node 1 to the node 2 will be described with reference to FIG. 6.

In the example of FIG. 6, the dummy generating unit 108 generates the dummy data using a different control scheme according to not only the accumulation state of the encryption key checked by the key monitoring unit 105 but also the communication state of the real data checked by the communication monitoring unit 106.

As illustrated in FIGS. 3 to 6, the node 1 has a sequence of photons transmission function of transmitting the sequence of photons to the node 2, and the node 2 has a sequence of photons reception function, but in communication of the encrypted data through the classical communication channel, each of the node 1 and the node 2 may be both a transmission side and a reception side.

FIG. 7 is a table used for deciding the communication amount of the dummy data according to the first embodiment. An example of an operation of deciding the communication amount of the dummy data will be described with reference to FIG. 7. Here, the description will proceed using the node 1 as an example.

The dummy generating unit 108 generates the dummy data the accumulation state of the encryption key checked by the key monitoring unit 105 and the communication state of the real data checked by the communication monitoring unit 106 as described above. Specifically, the dummy generating unit 108 decides the communication amount of the dummy data according to the accumulation amount of the encryption key accumulated in the key storage 103 and the number of communications (transmissions) of the real data by the communication unit 104, for example, as illustrated in FIG. 7. Here, for the accumulation amount of the encryption key accumulated in the key storage 103, for example, preferably, the accumulation amount is determined to be “large” when the accumulation amount is a predetermined amount or more, and the accumulation amount is determined to be “small” when the accumulation amount is less than a predetermined value. For the number of communications (transmissions) of the real data by the communication unit 104, for example, preferably, the number of communications is determined to be “large” when the number of communications during a predetermined recent period of time is a predetermined number of times or more, and the number of communications is determined to be “small” when the number of communications during the predetermined recent period of time is less than the predetermined number of times. The communication monitoring unit 106 determines whether the number of communications of the real data is large or small but may determine whether the communication data amount of the real data is large or small.

First, an example in which the number of communications of the real data is large, and the accumulation amount of the encryption key is small will be described with reference to FIG. 7. In this case, the dummy generating unit 108 has used up the encryption keys for communication of the real data, and few encryption keys remain in the key storage 103, and thus it is determined that there is no encryption key available for communication of the dummy data. Thus, the dummy generating unit 108 decides not to generate the dummy data. In other words, the communication amount of the dummy data is set to “0”.

Next, an example in which the number of communications of the real data is small, and the accumulation amount of the encryption key is large will be described. Further, when the key storage 103 manages the encryption key using a file of a predetermined size in, and the key monitoring unit 105 preferably determines the accumulation amount to be “large” when there are a predetermined number or more of encryption keys in the key storage 103. In this case, the dummy generating unit 108 determines that the encryption keys accumulated in the key storage 103 are not used up and remain. Therefore, preferably, the dummy generating unit 108 generates the dummy data twice or more, and the communication control unit 111 performs communication of the dummy data through the communication unit 104 twice or more. Further, when the dummy data is transmitted through the communication unit 104, the communication control unit 111 checks that transmission of the real data is not prepared yet and then performs transmission the dummy data. As described above, when there is an encryption key that is not used for communication of the real data in the key storage 103, the dummy generating unit 108 may constantly generates the dummy data, and the communication control unit 111 may constantly perform communication of the dummy data through the communication unit 104.

Further, when the number of communications of the real data is small, and the accumulation amount of the encryption key is large, the dummy generating unit 108 may generate and prepare the dummy data, and the communication control unit 111 may transmit the dummy data using the encryption key “as is” through the communication unit 104 without accumulating the encryption key in the key storage 103 when the key monitoring unit 105 confirms that the encryption key is generated by the key distilling unit 102. In this case, when the encryption key is generated by the key distilling unit 102, the communication control unit 111 determines whether or not the real data to be encrypted using the encryption key is stored in the application unit 107 or whether or not the real data to be decrypted using the encryption key is received, and processes the real data when there is the real data to be encrypted or decrypted. On the other hand, when there is no real data to be encrypted or decrypted, the data processing unit 109 generates the dummy data, and the communication control unit 111 transmits the dummy data encrypted by the encrypting unit 110 through the communication unit 104.

Next, an example in which the number of communications of the real data is small, and the accumulation amount of the encryption key is small and an example in which the number of communications of the real data is large, and the accumulation amount of the encryption key is large will be described. In this case, the generation of the dummy data by the dummy generating unit 108 and the communication amount of the dummy data by the communication control unit 111 are adjusted while keeping balance between effects of a concealment function by communication of the dummy data and influence on communication of the real data associated with a reduction in the number of encryption keys. Here, an example of an operation in which the communication control unit 111 decides the communication (transmission) amount of the dummy data while keeping the balance will be described. First, a communication concealment ratio R is defined as a request on the quantum cryptographic communication system 100. The communication concealment ratio R indicates a ratio of the communication amount of the entire data including the dummy data with respect to the communication amount of the real data. In other words, when the communication amount of the entire data including the dummy data with respect to the communication amount of the real data is R times, the communication concealment ratio is R. As the communication concealment ratio R increases, and the communication amount of the dummy data with respect to the real data increases, and thus an effect of concealing the communication of the real data can be considered to increase.

Here, an encryption key generation speed by the sharing operation of the encryption key (the quantum key distribution) is assumed to be T [bits/second]. At this time, in order to maintain the communication concealment ratio to be R, it is necessary to set the communication amount of the real data to increase up to T/R [bits/second] and set the dummy data communication amount to (T-T/R) [bits/second] at this time. As a specific example, for example, when the communication concealment ratio R is maintained to be 10, and the encryption key generation speed is set to 1 [M bits/second], it is necessary to set the communication amount of the real data to increase up to 100 [Kbits/second] and set the communication amount of the dummy data to 900 [Kbits/second].

When the key monitoring unit 105 confirms that the accumulation amount of the encryption key in the key storage 103 is not sufficient, or when the communication monitoring unit 106 confirms that the communication amount of the real data by the communication unit 104 is increasing, it can be coped with by reducing the communication concealment ratio R to be requested and reducing the communication amount of the dummy data. However, in this case, the effect of concealing the cryptographic data communication is reduced. On the other hand, when the key monitoring unit 105 confirms that the accumulation amount of the encryption key in the key storage 103 and the encryption key generation speed T are sufficiently larger than the communication amount of the real data or when the communication monitoring unit 106 confirms that the communication amount of the real data by the communication unit 104 is decreasing, the effect of concealing the cryptographic data communication can be improved by increasing the communication concealment ratio R, that is, increasing the proportion of the communication amount of the dummy data.

In order to maintain the communication concealment ratio R to be a requested value, it is desirable to control the communication amount of the dummy data transmitted from the communication unit 104 through the communication control unit 111, and the dummy data generation operation of the dummy generating unit 108 need not be necessarily associated with it. For example, it is desirable that the dummy generating unit 108 generates the dummy data in advance, accumulate the dummy data in the key storage 103 or the like, and extract the dummy data as necessary.

Next, the size of the dummy data generated by the dummy generating unit 108 will be described.

It is desirable to cause the size of the dummy data that is generated by the dummy generating unit 108 and transmitted once through the communication unit 104 by the communication control unit 111 to be equal to the size of the real data that is transmitted once for the purpose of concealing, for example, the communication content, the communication data amount, and the transmission timing of the real data. Practically, since the size of the real data is not always constant, for example, the dummy generating unit 108 preferably generates the dummy data of the size that is equal to at least one of an average value of the size of the real data, a median value of the size of the real data, or a pattern of the size of the real data.

It is described in the above that transmission control of the dummy data is performed according to the number of communications of the real data; however, it is allowable to perform transmission control of the dummy data according to the communication amount of the real data. It is further described in the above the method of performing transmission control of the dummy data according to both the number of communications of the real data and the amount of the encryption key accumulated; however, it is allowable to perform transmission control of the dummy data according to only either the amount of the encryption key accumulated or the number of communications (or the communication amount) of the real data.

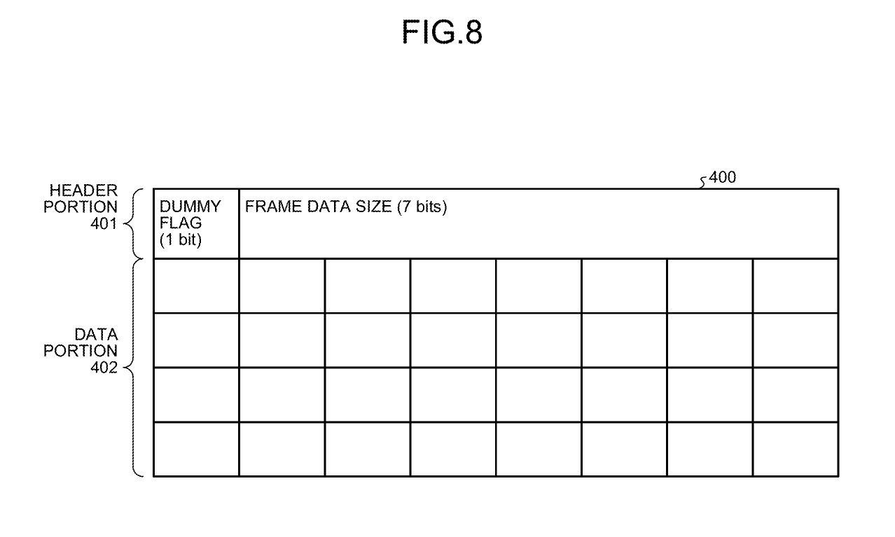

FIG. 8 is a diagram illustrating an example of a configuration of a frame that is transmitted and received according to the first embodiment (a header method). An example of an operation of encrypting and decrypting the data (the real data and the dummy data) that has undergone the data processing based on the header method will be described with reference to FIG. 8.

As the data processing based on the header method, the data processing unit 109 makes a frame format by adding a header that is a common format when the real data and the dummy data are transmitted as illustrated in FIG. 8. FIG. 8 illustrates an example of a frame that undergoes the data processing by the header method and then is transmitted and received. A frame 400 illustrated in FIG. 8 is configured with a header portion 401 and a data portion 402. The header portion 401 corresponds to a header added to the data (the real data or the dummy data), and includes a 1-bit dummy flag (identification information) indicating whether data included in the data portion 402 is the real data or the dummy data and a frame data size serving as information indicating the size of the data. The data portion 402 includes the real data or the dummy data.

When the real data is transmitted, for example, the data processing unit 109 generates the header portion by setting “0” to the dummy flag and setting information of the size of the real data stored in the data portion of the frame to the frame data size, and generates the frame by adding the generated header portion to the real data serving as the data portion. Then, the encrypting unit 110 encrypts the entire frame generated by the data processing unit 109 using the encryption key accumulated in the key storage 103 commonly based on the one-time pad. Then, the communication control unit 111 transmits the frame including the encrypted real data to the node 2 through the communication unit 104.

On the other hand, when the dummy data is transmitted, for example, the data processing unit 109 generates the header portion by setting “1” to the dummy flag and setting information of the size of the dummy data stored in the data portion of the frame to the frame data size, and generates the frame by adding the generated header portion to the dummy data serving as the data portion. Then, the encrypting unit 110 encrypts the entire frame generated by the data processing unit 109 or only the header portion using the encryption key accumulated in the key storage 103 commonly based on the one-time pad. Then, the communication control unit 111 transmits the frame including the dummy data in which at least a part is encrypted to the node 2 through the communication unit 104.

When only the header portion of the frame is encrypted for encryption the frame including the dummy data, it is possible to reduce a quantity of encryption keys consumed by the one-time pad at the time of transmission and reception of the dummy data. However, in this case, it is a premise that the dummy data generated by the dummy generating unit 108 is prepared as a random number bit string having the same level of quality as the encrypted data obtained by encrypting the real data using the encryption key. It is because, when the quality of the random number bit string obtained by encrypting the dummy data using the encryption key is different from that obtained by encrypting the real data using the encryption key, the eavesdropper who eavesdrops the frame is likely to find out whether the frame includes the real data or the dummy data.

Further, when the entire frame is encrypted in addition to the header portion of the frame for encryption of the frame including the dummy data, the encryption key is consumed at the same level as when the real data is transmitted and received at the time of transmission and reception of the dummy data. However, in this case, since the dummy data serving as the data portion is also encrypted, the dummy generating unit 108 need not generate the dummy data as the random number bit string and may generate, for example, a bit string of a simple pattern in which all bits are “0”.

As described above, in the node (here, the node 2) that has received the frame including the data (the real data and the dummy data) that has undergone the data processing based on the header method and been encrypted, first, the decrypting unit 212 decrypts a portion corresponding to the header portion of the encrypted frame using the encryption key accumulated in the key storage 203.

When the dummy flag of the decrypted header portion indicates “0”, the decrypting unit 212 determines that the data portion of the frame is the real data, and decrypts the encrypted data portion using the encryption key. Then, the data processing unit 209 removes the header portion from the decrypted frame, and transfers only the data portion, that is, the real data to the application unit 207.

When the dummy data of the decrypted header portion indicates “1”, the decrypting unit 212 determines that the data portion of the frame is the dummy data, decrypts the encrypted dummy data, and then discards the dummy data. The decrypting unit 212 may discard the encryption key corresponding to the size of the dummy data without decrypting the dummy data. In any case, it is necessary to perform control such that the same number of encryption keys are used and consumed at the transmission side node that encrypts the data and at the reception side node that decrypts the data.

As described above, the node can transmit and receive the real data and the dummy data through the data processing based on the header method, and the reception side node can extract the real data from the received frame or discard the dummy data based on the dummy flag of the header portion.

In the above example, the 1-bit dummy flag is set in the header portion in order to distinguish whether or not there is the dummy data, but the present embodiment is not limited thereto. For example, as a general communication protocol technology, a technology of including information such as a port number or a protocol number of an application (hereinafter, referred to collectively as a “protocol number”) in the header portion added to the data that is transmitted and received and implementing communications of a plurality of protocols identified by the protocol number at the same time is known. Here, for example, a method of setting a special protocol number for transmitting and receiving the dummy data may be used. In this case, when the dummy data is transmitted, the transmission side node designates the special protocol number (hereinafter, referred to as a “dummy data protocol number”) indicating that the data portion is the dummy data as the protocol number included in the header portion and transmits the resulting header portion. Then, a method in which the reception side node decrypts the header portion, discards the dummy data when the protocol number is the dummy data protocol number, determines that there is the real data when the protocol number is any other protocol number, and transfers the real data to an application may be used. According to this method, the above operation can be implemented by adding an upper-level protocol processing function for transmission and reception of the dummy data that undertakes transmission and reception of the dummy data or a dummy data transmission/reception application to a system using a standard frame format capable of identifying a plurality of types of communications based on the protocol number or the port number which is represented by Transmission Control Protocol (TCP), User Datagram Protocol (UDP), Internet Protocol (IP), and Ethernet (a registered trademark), or the like.

Next, the transmission timing of the dummy data by the communication control unit 111 will be described.

It is desirable to select a timing at which the dummy data is transmitted through the communication control unit 11 based on a timing at which the real data is transmitted so that the timing is concealed. For example, when the size of the dummy data generated by the dummy generating unit 108 and the communication amount of the dummy data communicated by the communication control unit 111 (the amount of the dummy data generated by the dummy generating unit 108) are decided as described above, the communication control unit 111 can decide time intervals at which the dummy data can be transmitted with the decided size. For example, a method of periodically transmitting the dummy data based on the timing at which the real data is transmitted is considered. However, it is difficult to accurately know a next timing at which the real data is transmitted. Further, when the dummy data is transmitted at strict periodic intervals, data that is not transmitted with the strict period is likely to be recognized as the real data. In this regard, even when the dummy data is periodically transmitted, the communication control unit 111 preferably takes, for example, a countermeasure of changing the periodic timings backward or forward by a random period of time. As a result, the effect of concealing the transmission timing of the real data can be improved.

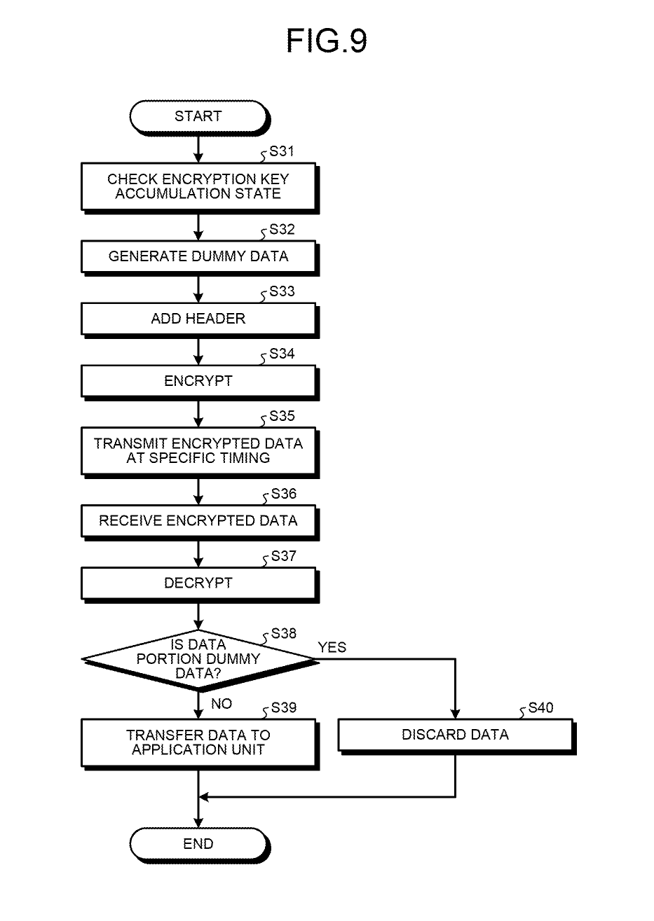

FIG. 9 is a sequence diagram illustrating an example of a cryptographic data communication operation in the quantum cryptographic communication system according to the first embodiment. The flow of the cryptographic data communication operation in the quantum cryptographic communication system 100 according to the present embodiment will be described with reference to FIG. 9. An operation of transmitting the encrypted data from the node 1 to the node 2 will be described with reference to FIG. 9 as an example.

Step S31

The key monitoring unit 105 of the node 1 checks the accumulation state of the encryption key accumulated in the key storage 103. At that time, the communication monitoring unit 106 of the node 1 may check the communication state of the real data that is communicated on the classical communication channel through the communication unit 104. The key monitoring unit 105 and the communication monitoring unit 106 transfer the checked results to the dummy generating unit 108. Then, the process proceeds to step S32.

Step S32

The dummy generating unit 10 of the node 1 generates the dummy data according to the accumulation state of the encryption key checked by the key monitoring unit 105 and the communication state of the real data checked by the communication monitoring unit 106. The amount of the dummy data generated by the dummy generating unit 108 is decided according to the accumulation amount of the encryption key accumulated in the key storage 103 and the number of communications (transmissions) of the real data by the communication unit 104, for example, as illustrated in FIG. 7. The dummy generating unit 108 transfers the generated dummy data to the data processing unit 109.

The real data to be transmitted by the application unit 107 is also transferred to the data processing unit 109. Then, the process proceeds to step S33.

Step S33

When the real data and the dummy data are transmitted, the data processing unit 109 of the node 1 makes a frame format by adding a header that is a common format, for example, as illustrated in FIG. 8. When the real data is transmitted, for example, the data processing unit 109 generates the header portion by setting “0” to the dummy flag and setting information of the size of the real data stored in the data portion of the frame to the frame data size, and generates the frame by adding the generated header portion to the real data serving as the data portion. On the other hand, when the dummy data is transmitted, for example, the data processing unit 109 generates the header portion by setting “1” to the dummy flag and setting information of the size of the dummy data stored in the data portion of the frame to the frame data size, and generates the frame by adding the generated header portion to the dummy data serving as the data portion. The data processing unit 109 transfers the generated frame to the encrypting unit 110. Then, the process proceeds to step S34.

Step S34

When the frame of the real data is generated by the data processing unit 109, the encrypting unit 110 of the node 1 encrypts the entire frame using the encryption key accumulated in the key storage 103 commonly based on the one-time pad. Further, when the frame of the dummy data is generated by the data processing unit 109, the encrypting unit 110 encrypts the entire frame or only the header portion using the encryption key accumulated in the key storage 103 commonly based on the one-time pad. The encrypting unit 110 transfers the encrypted frame (the encrypted data) to the communication control unit 111. Then, the process proceeds to step S35.

Step S35

The communication control unit 111 of the node 1 transmits the encrypted data of the real data through the communication unit 104 and the classical communication channel at a necessary timing, and transmits the encrypted data of the dummy data at a specific timing. For example, as described above, when the size of the dummy data generated by the dummy generating unit 103 and the communication amount of the dummy data that is communicated by the communication control unit 111 are decided, the communication control unit 111 can decide time intervals at which the dummy data can be transmitted with the decided size. Then, the communication control unit 111 periodically transmits the dummy data through the communication unit 104 and the classical communication channel, for example, while delaying the periodic timings by a random period of time. Then, the process proceeds to step S36.

Step S36

The communication control unit 211 of the node 2 receives the encrypted data from the node 1 through the classical communication channel and the communication unit 204. The communication control unit 211 transfers the received encrypted data to the decrypting unit 212. Then, the process proceeds to step S37.

Step S37

The decrypting unit 212 of the node 2 decrypts a portion corresponding to the header portion of the encrypted frame (the encrypted data) using the encryption key accumulated in the key storage 203. Then, the process proceeds to step S38.

Step S38

When the dummy flag of the decrypted header portion indicates “0”, the decrypting unit 212 determines that the data portion of the frame is the real data (No in step S38), decrypts the encrypted data portion using the encryption key, and transfers the decrypted frame to the data processing unit 209. Then, the process proceeds to step S39.

On the other hand, when the dummy data of the decrypted header portion indicates “1”, the decrypting unit 212 determines that the data portion of the frame is the dummy data (Yes in step S38), and the process proceeds to step S40.

Step S39

The data processing unit 209 of the node 2 removes the header portion from the decrypted frame, and transfers only the data portion, that is, the real data to the application unit 207.

Step S40

When the data portion of the frame is determined to be the dummy data, the decrypting unit 212 decrypts the dummy data as well and then discards the dummy data. The decrypting unit 212 may discard the encryption key corresponding to the size of the dummy data without decrypting the dummy data. However, control is performed such that the same number of encryption keys are used and consumed at the transmission side node that encrypts the data and at the reception side node that decrypts the data.

As steps S31 to S40 described above are repeated, the cryptographic data communication in which the cryptographic data communication of the real data is concealed is implemented.

The communication concealment function effective for the cryptographic data communication of the real data by the quantum encryption technology can be implemented by deciding the communication amount of the dummy data (the amount of the generated dummy data), the size of the dummy data, the transmission timing, and the like based on the accumulation state of the encryption key checked by the key monitoring unit 105 (205) and the communication state of the real data on the classical communication channel checked by the communication monitoring unit 106 (206) as described above.

Since the header portion including the dummy flag indicating whether the data (the real data and the dummy data) is the real data or the dummy data is added to the data as the data processing by the data processing unit 109 (209), the reception side node can detect whether the received encrypted data (the encrypted frame) includes the real data or the dummy data.

### Second Embodiment

A quantum cryptographic communication system 100 according to a second embodiment will be described focusing on different points with the quantum cryptographic communication system 100 according to the first embodiment. In the first embodiment, the operation (the header method) of adding the header to the data (the real data and the dummy data) has been described as the data processing by the data processing unit 109 (209). In the present embodiment, an operation (an encoding method) of encoding data according to a predetermined method will be described as the data processing by the data processing unit 109 (209). A configuration of the quantum cryptographic communication system 100 according to the present embodiment, a hardware configuration of a node, a functional block configuration of a node, and the sharing operation of the encryption key are the same as in the first embodiment.

The functional block configuration of the node according to the present embodiment is the same as the functional block configurations of the nodes 1 and 2 illustrated in FIG. 3 as described above, but the description will proceed with a different operation from that of the first embodiment.

When the real data and the dummy data are transmitted through the communication control unit 111, the data processing unit 109 of the node 1 generates transmission data to which a control bit string indicating a timing of switching between communication of the real data and communication of the dummy data is added as the data processing. At this time, the data processing unit 109 encodes the real data and the dummy data according to a predetermined method. The operation of adding and encoding the control bit string as the data processing of the data processing unit 109 will be described later.

When the real data and the dummy data are transmitted through the communication control unit 211, the data processing unit 209 of the node 2 generates transmission data to which the control bit string indicating the timing of switching between communication of the real data and communication of the dummy data is added as the data processing. At this time, the data processing unit 209 encodes the real data and the dummy data according to a predetermined method. The operation of adding and encoding the control bit string as the data processing of the data processing unit 209 will be described later.

The other function units of the nodes 1 and 2 perform the same operations as the operations described with reference to FIG. 3 in the first embodiment.

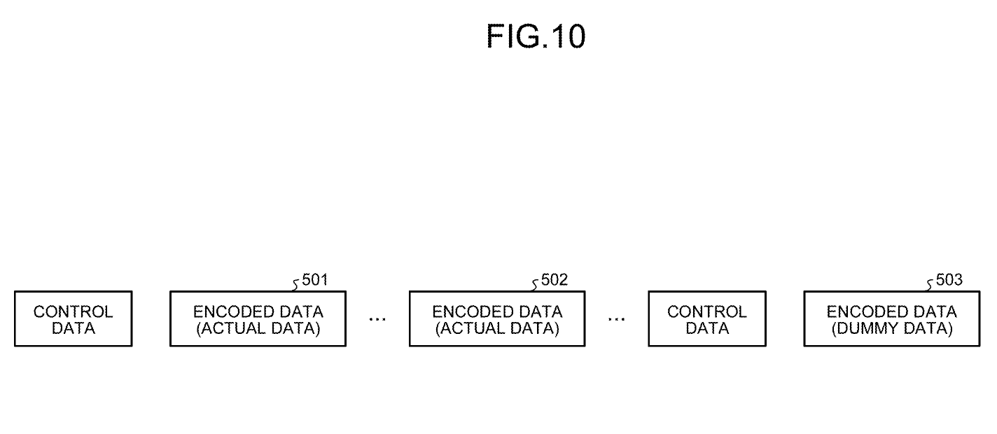

FIG. 10 is a diagram for describing the encoding method according to the second embodiment. An operation of encrypting and decrypting data that has undergone the data processing based on the encoding method (the real data and the dummy data) will be described with reference to FIG. 10.

First, when the real data and the dummy data are transmitted through the communication control unit 111, the data processing unit 109 arranges the control bit string (control data) indicating the timing of switching between communication of the real data and communication of the dummy data and generates the transmission data through the data processing. For example, the control bit string is assumed to be “1” among 10 consecutive bits. The data processing unit 109 arranges the control bit string (control data) indicating that transmission of the real data ends, and transmission of the dummy data starts, for example, directly before data 503 illustrated in FIG. 10 obtained by encoding the dummy data. Alternatively, the data processing unit 109 arranges the control bit string (control data) indicating that transmission of the dummy data ends, and transmission of the real data starts, for example, directly before data 501 illustrated in FIG. 10 obtained by encoding the real data. Further, when the real data is transmitted subsequently to the real data that is transmitted immediately before as in data 502 illustrate in FIG. 10, since the control bit string (control data) is unnecessary, the transmission data may be transmitted subsequently to the real data. The same applies to the dummy data.

Here, for example, when a bit string of the same sequence as the control bit string (control data) appears in the real data to be transmitted, it is determined to be the control bit string, and the real data subsequent thereto is dealt as the dummy data. In order to prevent this, the data processing unit 109 encodes the real data according to a predetermined method so that no control bit string (here, “1111111111”) appears in the bit string of the real data as the data processing.

As such an encoding method, for example, an 8b10b scheme may be used. In 8b10b, 8-bit data is converted (encoded) into 10-bit data. Specifically, the data processing unit 109 first delimits data to be transmitted in units of 8 bits, and converts (encodes) each 8-bit data string into a 10-bit data string. The control bit string employs 10 bits of a bit pattern that does not exist in a converted 10-bit data string. The data processing unit 109 converts 8-bit data into 10-bit data, and inserts the control bit string into an appropriate position. Then, the encrypting unit 110 encrypts the encoded real data and the control bit string inserted thereinto.

The decrypting unit 212 of the node 2 at the reception side decrypts the received data, and the data processing unit 209 performs conversion (encoding) from 10-bit data into 8-bit data on the decrypted data, and extracts the control bit string included therein.

On the other hand, in the case of the dummy data, a method of generating a known bit string in which no control bit string appears such as a bit string in which all bits are “0” through the dummy generating unit 108 and a method of encoding the dummy data, similarly to the real data, so that no control bit string appears in the random number bit string generated by the dummy generating unit 108 are considered. Here, when the method of generating a known bit string as the dummy data is used, the encrypting unit 110 needs to encrypt the dummy data using the encryption key (commonly) based on the one-time pad. On the other hand, when encoding is performed using a random number bit string as the dummy data, if a quality of the random number bit string is sufficient, the encrypting unit 110 need not encrypt the encoded dummy data.

As described above, the data processing unit 209 can extract the dummy data or the real data as the decoded data.

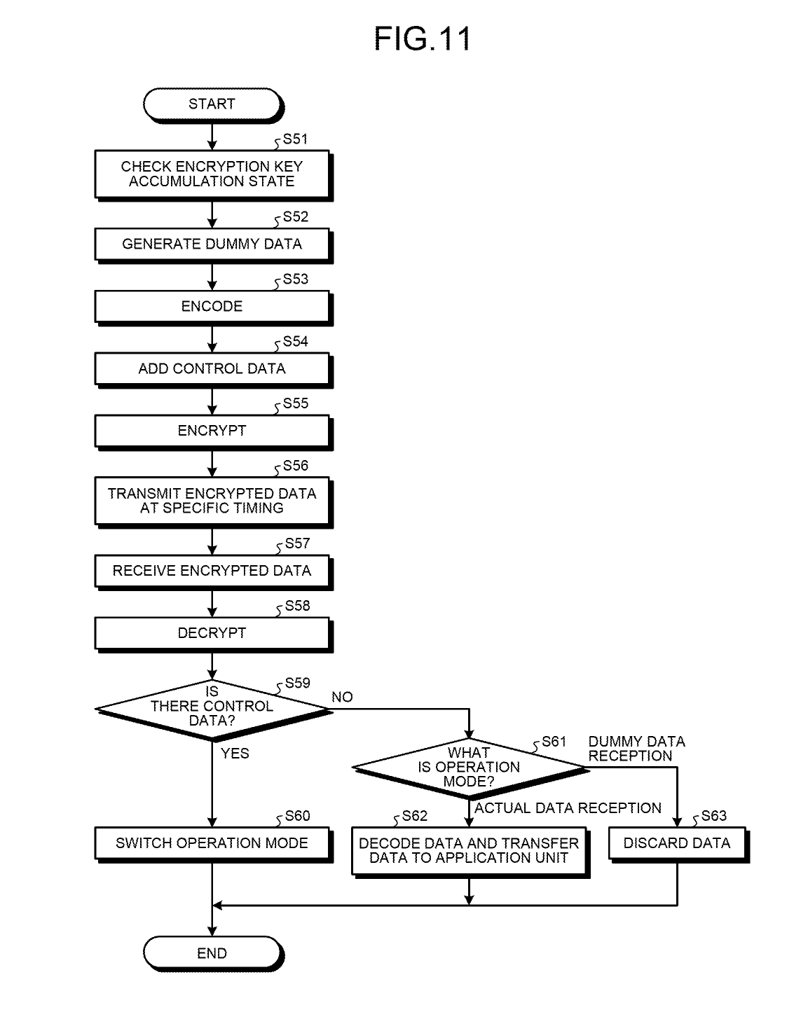

FIG. 11 is a sequence diagram illustrating an example of a quantum cryptographic communication operation in the quantum cryptographic communication system according to the second embodiment. The flow of the cryptographic data communication (quantum cryptographic communication) operation in the quantum cryptographic communication system 100 according to the present embodiment will be described with reference to FIG. 11. An operation of transmitting the encrypted data from the node 1 to the node 2 will be described with reference to FIG. 11 as an example.

Steps S51 and S52

A process of steps S51 and S52 is the same as steps S31 and S32 illustrated in FIG. 9 in the first embodiment. Then, the process proceeds to step S53.

Step S53

The data processing unit 109 of the node 1 encodes the real data according to a predetermined method (for example, 8b10b) so that no control bit string appears in the bit string of the real data as the data processing. Further, the data processing unit 109 performs encoding, similarly to the real data so that no control bit string appears in the random number bit string generated by the dummy generating unit 108 as the data processing. The data processing unit 109 need not particularly perform encoding when a known bit string in which no control bit string appears such as a bit string in which all bits are “0” is generated by the dummy generating unit 108. Then, the process proceeds to step S54.

Step S54

The data processing unit 109 adds (inserts) the control bit string (control data) indicating the timing of switching between communication of the real data and communication of the dummy data when the encoded real data and the dummy data are transmitted through the communication control unit 111 as the data processing. The data processing unit 109 transfers data in which the control bit is inserted into the encoded real data and the dummy data to the encrypting unit 110. Then, the process proceeds to step S55.

Step S55

The encrypting unit 110 of the node 1 encrypts the real data and the dummy data encoded by the data processing unit 109 and the inserted control bit string using the encryption key accumulated in the key storage 103 commonly based on the one-time pad. Further, when encoding is performed using the random number bit string as the dummy data, the encrypting unit 110 need not encrypt the encoded dummy data when the quality of the random number bit string is sufficient. Then, the process proceeds to step S56.

Step S56

The communication control unit 111 of the node 1 may transmit the encrypted data of the real data at a necessary timing and may transmit the encrypted data of the dummy data as a specific timing through the communication unit 104 and the classical communication channel. For example, when the size of the dummy data generated by the dummy generating unit 10E and the communication amount of the dummy data that is communicated by the communication control unit 111 are decided as described above, the communication control unit 111 can decide time intervals at which the dummy data can be transmitted with the decided size. Here, in step S54, the communication control unit 111 causes the data processing unit 109 to add (insert) the control bit string (control data) indicating the timing of switching between communication of the real data and communication of the dummy data so that the dummy data is periodically transmitted while delaying the periodic timings by a random period of time, and thus the encrypted data of the dummy data are transmitted at specific timings. Then, the process proceeds to step S57.

Step S57

The communication control unit 211 of the node 2 receives the encrypted data from the node 1 through the classical communication channel and the communication unit 204. The commination control unit 211 transfers the received encrypted data to the decrypting unit 212. Then, the process proceeds to step S58.

Step S58

The decrypting unit 212 of the node 2 decrypts the encrypted data using the encryption key accumulated in the key storage 203, and transfers the decrypted data to the data processing unit 209. Then, the process proceeds to step S59.

Step S59

The data processing unit 209 of the node 2 checks whether or not there is the control bit string (control data) in the decrypted data. When the control data is confirmed (Yes in step S59), the process proceeds to step S60, and when the control data is not confirmed (No in step S59), the process proceeds to step S61.

Step S60

The data processing unit 209 performs switching between an operation mode in which the real data is received and an operation mode in which the dummy data is received. In other words, when the current operation mode is the operation mode in which the real data is received, the data processing unit 209 performs switching to the operation mode in which the dummy data is received. On the other hand, when the current operation mode is the operation mode in which the dummy data is received, the data processing unit 209 performs switching to the operation mode in which the real data is received. The data processing unit 209 may receive one type of control data and perform control such that switching between the two operation modes is performed. Further, control data for switching to the operation mode in which the real data is received and control data for switching to the operation mode in which the dummy data is received may be a plurality of different pieces of control data. There may be an operation mode in addition to the two operation modes. A process in the operation mode in which the real data is received and a process in the operation mode in which the dummy data is received will be described in detail in steps S62 and S63.

Step S61

The data processing unit 209 determines whether the current operation mode is the operation mode in which the real data is received or the operation mode in which the dummy data is received. When the current operation mode is the operation mode in which the real data is received (real data reception in step S61), the process proceeds to step S62, and when the current operation mode is the operation mode in which the dummy data is received (dummy data reception in step S61), the process proceeds to step S63.

Step S62

The data processing unit 209 determines that the decrypted data is the real data, decodes the data, and transfers the decoded data to the application unit 207.

Step S63

The data processing unit 209 determines that the decrypted data is the dummy data, and discards the data. In this case, the data processing unit 209 may perform the decoding or may not perform the decoding.

The communication concealment function effective for the cryptographic data communication of the real data by the quantum encryption technology can be implemented by deciding the communication amount of the dummy data (the amount of the generated dummy data), the size of the dummy data, the transmission timing, and the like based on the accumulation state of the encryption key checked by the key monitoring unit 105 (205) and the communication state of the real data on the classical communication channel checked by the communication monitoring unit 106 (206) as described above.

Further, as the data processing by the data processing unit 109 (209), when the real data and the dummy data are transmitted, the control bit string (control data) indicating the timing of switching between communication of the real data and communication of the dummy data is added, and encoding is performed as necessary so that no control bit string appears in the real data and the dummy data. As a result, the reception side node can detect that data subsequent to the control bit string is the real data or the dummy data by checking whether or not there is the control bit string in the decrypted data.

In the first and second embodiments, the header method and the encoding method have been described as the data processing on the real data and the dummy data as examples, but the present embodiment is not limited thereto, and the data processing can be performed by any other method as long as the real data and the dummy data can be distinguished.

A program executed in a node (a communication device) according to the above embodiments may be embedded in, for example, the ROM 302 or the like and provided.

The program executed in the node according to the above embodiments may be a file of an installable format or an executable format and may be configured to be recorded in a computer readable recording medium such as Compact Disk Read Only Memory (CD-ROM), flexible disk (FD), Compact Disk Recordable (CD-R), or Digital Versatile Disk (DVD) and provided as a computer program product.

The program executed in the node according to the above embodiments may be configured to be stored in a computer connected to a network such as the Internet, downloaded via a network, and provided. The program executed in the node according to the above embodiments may be configured to be provided or distributed via a network such as the internet.

The program executed in the node according to the above embodiments may cause a computer to function as the above-described function units of the node. The computer can read the program from a computer readable storage medium onto a main storage device and execute the program through the CPU 301.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device that communicates with another communication device using an encryption key shared through a quantum key distribution, comprising:
a communication unit configured to communicate data with the another communication device;
an encrypting unit configured to encrypt the data using the encryption key;
a first checking unit configured to check an accumulation amount of the encryption key; and
a communication control unit configured to transmit encrypted real data through the communication unit and to control transmission of dummy data that is different from the real data according to a checked result of the first checking unit.

2. The communication device according to claim 1, wherein
the communication control unit is configured to control at least one of a transmission amount of the dummy data, a size of the dummy data, and a transmission timing of the dummy data.

3. The communication device according to claim 1, further comprising:
a data processing unit configured to add a header including identification information identifying whether or not the data is the dummy data to the real data and the dummy data; and
a decrypting unit configured to decrypt the encrypted data received through the communication unit using the encryption key,
wherein the encrypting unit encrypts both the real data and the header added to the real data, and encrypts at least the header of the dummy data and the header added to the dummy data, and
the decrypting unit decrypts a portion corresponding to at least the header among the encrypted data, and when the header indicates the dummy data, the decrypting unit discards the data to which the header is added as the dummy data.

4. The communication device according to claim 3, further comprising:
a generating unit configured to generate a random number sequence as the dummy data, wherein
the encrypting unit encrypts the header added to the dummy data and the dummy data.

5. The communication device according to claim 3,
wherein the data processing unit sets a specific protocol number or a specific port number indicating the dummy data to a protocol number or a port number in a frame format as the identification information in the header added to the dummy data.

6. The communication device according to claim 1, further comprising:
a data processing unit configured to, when data to be transmitted is switched from the real data to the dummy data or switched from the dummy data to the real data, insert control data indicating switching and encode at least the real data so that the same bit string as the control data does not appear; and
a decrypting unit configured to decrypt the encrypted data received through the communication unit using the encryption key,
wherein the encrypting unit encrypts the control data and data obtained by encoding at least the real data, and
the data processing unit
when the data decrypted by the decrypting unit is the control data, performs switching to a different operation mode from a current operation mode, the different operation mode and the current operation mode including an operation mode in which the real data is received and an operation mode in which the dummy data is received,
when the data decrypted by the decrypting unit is not the control data, and the current operation mode is the operation mode in which the real data is received, decodes the data decrypted by the decrypting unit, and
when the data decrypted by the decrypting unit is not the control data, and the current operation mode is the operation mode in which the dummy data is received, discards the data decrypted by the decrypting unit.

7. The communication device according to claim 6, further comprising:
a generating unit configured to generate the dummy data so that the same bit string as the control data does not appear, wherein
the data processing unit encodes the real data, and
the encrypting unit encrypts the control data, the dummy data, and the encoded real data.

8. The communication device according to claim 6,
wherein the generating unit generates a random number sequence as the dummy data,
the data processing unit encodes the real data and the dummy data, and
the encrypting unit encrypts the encoded real data and the control data.

9. The communication device according to claim 1,
wherein, when the first checking unit detects that the encryption key is generated, and there is neither the real data to be transmitted nor data received by the communication unit, the communication control unit transmits the dummy data through the communication unit.

10. The communication device according to claim 1,
wherein the communication control unit
increases a transmission amount of the dummy data with an increase in an accumulation amount of the encryption key or an increase in an amount of the encryption key generated, and
decreases the transmission amount of the dummy data with a decrease in the accumulation amount of the encryption key or a decrease in the amount of the encryption key generated.

11. The communication device according to claim 1, further comprising:
a second checking unit configured to check a communication state of the real data by the communication unit; wherein
the communication control unit
decreases a transmission amount of the dummy data with an increase in a communication amount of the real data by the communication unit, and
increases the transmission amount of the dummy data with a decrease in the communication amount of the real data by the communication unit.

12. The communication device according to claim 1,
wherein the communication control unit transmits the dummy data with a communication amount according to a generation speed of the encryption key so that a predetermined communication concealment ratio is maintained.

13. The communication device according to claim 12,
wherein the communication control unit transmits the dummy data with a communication amount calculated by (T-T/R), where R indicates the communication concealment ratio, and T indicates the generation speed of the encryption key.

14. The communication device according to claim 1,
wherein in a period decided based on a size of the real data that and a communication amount of the dummy data, the communication control unit transmits the dummy data at timings obtained by changing timings of the period forward or backward by a random period of time.

15. A cryptographic communication system, comprising:
a plurality of communication devices configured to communicate with another communication device using an encryption key shared through a quantum key distribution,
at least one of the plurality of communication devices including
a communication unit configured to communicate data with the another communication device;
an encrypting unit configured to encrypt the data using the encryption key;
a first checking unit configured to check an accumulation amount of the encryption key; and
a communication control unit configured to transmit encrypted real data through the communication unit and to control transmission of dummy data that is different from the real data according to a checked result of the first checking unit.

16. A cryptographic communication method of a communication device that communicate with another communication device using an encryption key shared through a quantum key distribution, comprising:
encrypting data using the encryption key;
checking an accumulation amount of the encryption key;
transmitting encrypted real data through the communication unit; and
controlling transmission of dummy data that is different from the real data according to checked results.

17. A computer program product comprising a computer-readable medium containing a program causing a computer configured to communicate key with another communication device using an encryption key shared through a quantum key distribution, the program causing the computer to execute:
encrypting data using the encryption key;
checking an accumulation amount of the encryption key;
transmitting encrypted real data through the communication unit; and
controlling transmission of dummy data that is different from the real data according to checked results.
